(19) United States
(12) Patent Application Publication
(10) Pub. No.: US 2016/0229155 A1
(43) Pub. Date: Aug. 11, 2016

(54) COMPOSITE PANE, COMPOSED OF A POLYMERIC PANE AND A GLASS PANE

(71) Applicant: SAINT-GOBAIN GLASS FRANCE, Courbevoie (FR)

(72) Inventors: Sandra SIENERTH, AACHEN (DE); Stephan KREMERS, HEINSBERG (DE); Rene GY, BONDY (FR)

(21) Appl. No.: 15/029,956

(22) PCT Filed: Aug. 22, 2014
(86) PCT No.: PCT/EP2014/067902

§ 371 Date: Apr. 15, 2016

(30) Foreign Application Priority Data
Oct. 23, 2013 (EP) 13189858.7

(51) Int. Cl. B32B 17/10; B60J 7/00; B60J 1/18; B60J 1/02; B60J 1/08

(52) U.S. Cl. CPC B32B 17/10018; B32B 17/10137; B32B 17/1077; B60J 1/02; B60J 1/08; B60J 1/18; B60J 7/00; B32B 2369/00

(57) ABSTRACT

A composite pane for vehicles is described. The composite pane comprising a polymeric pane, which has a thickness of 1.5 to 10 mm, and a glass pane, which has a thickness less than or equal to 1 mm and is connected to the polymeric pane in a planar manner, wherein the polymeric pane contains at least polycarbonate (PC) and/or polymethyl methacrylate (PMMA) and the glass pane is a chemically tempered glass pane.

The invention relates to a composite pane composed of a polymeric pane and a glass pane, a method for its production, and the use of a thin glass pane in such a composite pane.

The automotive industry is currently endeavoring to reduce the weight of vehicles, which is, in particular, associated with reduced fuel consumption. One factor that significantly contributes to the weight of vehicles and, consequently, offers significant potential savings is the glazing. Conventional vehicle glazings are realized by glass panes, customarily as single-pane safety glass or laminated safety glass. The term “single-pane safety glass” means a single glass pane that is tempered to influence the stability and the size of fragments in the event of breakage of the pane. The term “laminated safety glass” means a composite pane composed of two customarily non-tempered glass panes, which are bonded to each other via a thermoplastic intermediate layer.

One approach to reducing the weight of vehicle glazing is the use of plastic panes instead of glass panes. However, compared to glass panes, plastic panes have some disadvantages, in particular significantly low scratch resistance such that the replacement of significant portions of vehicle glazing with plastic panes has not yet been possible to realize.

To increase scratch resistance, DE4415878A1 proposes bonding the plastic pane to a thin glass pane by means of a silicone adhesive.

The object of the present invention is to provide a further improved vehicle pane that has low weight and, at the same time, high stability and scratch resistance as well as a method for its production.

The object of the present invention is accomplished according to the invention by a composite pane for vehicles in accordance with claim 1. Preferred embodiments emerge from the subclaims.

The composite pane according to the invention for vehicles comprises at least one polymeric pane (plastic pane) and one glass pane bonded in a planar manner to the polymeric pane.

The composite pane according to the invention is intended, in a window opening of a vehicle, to separate the interior from the external environment. The pane of the composite glass facing the interior is referred to as the inner pane. The pane facing the external environment is referred to as the outer pane.

The major advantage of the invention consists in the combining of a polymeric pane with a very thin glass pane. As a result of the polymeric pane, which, as a rule, constitutes the greatest part of the thickness of the composite pane, the composite pane has a low weight. The pane can thus advantageously contribute to a reduction in the total weight of the vehicle. The glass pane is very thin, and, consequently, results in only a slight increase in the weight of the pane. Nevertheless, as a result of the glass pane, high stability and, in particular, scratch resistance of the pane is achieved. Moreover, the glass pane improves the acoustic properties of the pane, thus effects a reduction in the noise penetrating the pane, which is frequently described as a disadvantage of plastic panes compared to glass panes.

The glass pane is preferably chemically tempered. By means of tempering, the glass pane can be provided with special break stability and scratch resistance. For a very thin glass pane, as is provided according to the invention, chemical tempering is more suitable than thermal tempering. Since thermal tempering is based on a temperature differential between a surface zone and a core zone, thermal tempering requires a minimum thickness of the glass panes. Adequate stresses can typically be obtained with commercially available thermal tempering systems with glass thicknesses starting at roughly 2.5 mm. With lower glass thicknesses, the generally required values for tempering cannot, as a rule, be obtained (cf., for example, ECE Regulation 43). With chemical tempering, the chemical composition of the glass is altered by ion exchange in the region of the surface of the glass, with the ion exchange restricted by diffusion to a surface zone. Consequently, chemical tempering is especially suitable for thin panes.

Chemical tempering is also commonly referred to as chemical prestressing, chemical hardening, or chemical strengthening. Chemically tempered glass panes for the automotive sector are known, for example, from DE1946358 and GB1339980.

The stability of the glass pane can be improved by suitable values and local distributions of stresses, which are generated in the case of chemical tempering by incorporation of ions during chemical tempering.

In an advantageous embodiment, the glass pane has a surface compressive stress greater than 100 MPa, preferably greater than 250 MPa and particularly preferably greater than 350 MPa.

The compressive stress depth of the glass pane is preferably at least one tenth of the thickness of the glass pane, preferably at least one sixth of the thickness of the glass pane, for example, roughly one fifth of the thickness of the glass pane. This is advantageous with regard to the break resistance of the pane. The compressive stress depth of the glass pane is, with adequate pane thickness, preferably greater than 50 μm, particularly preferably greater than 100 μm. In the context of the invention, the term “compressive stress depth” means the depth measured from the surface of the pane to which the pane is under compressive stresses in an amount greater than 0 MPa.

The glass pane preferably has a thickness less than or equal to 1 mm. Panes of this thickness have only a low weight, yet achieve high stability and scratch resistance. The glass pane particularly preferably has a thickness of 0.1 mm to 1 mm, most particularly preferably of 0.2 to 0.8 mm, and, in particular, of 0.4 mm to 0.7 mm. Thus, particularly good results are obtained with regard to low weight and high stability and scratch resistance.

The polymeric pane preferably has a thickness of 1.5 mm to 10 mm, particularly preferably of 2 mm to 5 mm, and most particularly preferably of 2.5 mm to 4 mm, in particular of 3 mm to 4 mm. With a polymeric pane of this thickness, the pane according to the invention has adequately high stability to be used as a vehicle pane.

The polymeric pane can contain, at least polycarbonate (PC), polymethyl methacrylate (PMMA), polyethylene (PE), polypropylene (PP), polystyrene (PS), polybutadiene, polynitriles, polyesters, polyurethanes, and/or polyacrylates. The polymeric pane preferably contains at least polycarbonate (PC), polymethyl methacrylate (PMMA), or copolymers or mixtures or derivatives thereof, particularly preferably polycarbonate or derivatives thereof.

The polymeric pane and the glass pane are, in an advantageous embodiment of the invention, bonded to each other via a thermoplastic intermediate layer. The thermoplastic intermediate layer can contain, for example, at least polyvinyl butyral (PVB), ethylene vinyl acetate (EVA), polyurethane (PU), or mixtures or copolymers or derivatives thereof. In a preferred embodiment, the intermediate layer contains polyurethane or derivatives thereof. It has surprisingly been found that these materials are particularly suited for the intermediate layer for laminating the composite pane. In comparison with other thermoplastic materials, in particular with the material PVB, widespread for composite panes, they effect, during the lamination process, low diffusion between the polymer layer and the intermediate layer. Such diffusion can, in particular, result in degraded optical properties and degraded adhesion properties, which must be avoided for window panes.

The thickness of the thermoplastic intermediate layer is preferably 0.2 mm to 1 mm, particularly preferably 0.3 mm to 0.9 mm, for example, 0.38 mm, 0.76 mm or 0.86 mm. The thermoplastic intermediate layer is formed by a single one or by a plurality of thermoplastic films.

In a particularly advantageous embodiment, the thermoplastic intermediate layer has a noise reducing effect. As a result, the transmission of noises into the vehicle interior can advantageously be further reduced. The vehicle occupants are thus bothered less by ambient noise and driving noise. Such an effect can be achieved by means of a multilayer, for example, three layer intermediate layer, wherein the inner layer has higher plasticity or elasticity than the outer layers surrounding it, for example, as a result of a higher content of plasticizers.

However, the polymeric pane and the glass pane can, alternatively, also be bonded to each other via an adhesive, for example, a chemically curing adhesive such as silicone adhesive.

In a preferred embodiment of the invention, the glass pane is the outer pane of the composite pane. Since damaging effects strike a vehicle pane especially from the outside environment, this arrangement is particularly advantageous for enhancing the stability of the pane.

In one embodiment of the invention, the surfaces of the glass pane and of the polymeric pane facing away from each other form the outer surfaces of the composite pane. In particular, the composite pane consists of the polymeric pane, the glass pane, all of and the thermoplastic intermediate layer between the panes, where the components mentioned can, however, also be provided with coatings. One example of such a coating is a scratch resistant coating on the outer surface of the polymeric pane.

In an alternative embodiment of the invention, the surface of the polymeric pane facing away from the (first) glass pane according to the invention is bonded in a planar manner to a second glass pane. In this case, the two surfaces of the polymeric pane are thus bonded in each case to a glass pane according to the invention. Thus, both surfaces of the polymeric pane are protected against damage. The second glass pane preferably has a thickness less than or equal to 1 mm, particularly preferably 0.1 mm to 1 mm, most particularly preferably 0.2 to 0.8 mm, and in particular 0.4 mm to 0.7 mm. The second glass pane is likewise preferably chemically tempered.

The glass pane can, in principle, have any chemical composition known to the person skilled in the art. The glass pane can, for example, contain soda lime glass or borosilicate glass or be made of these glasses. The glass pane must, of course, be suitable to be chemically tempered, and, in particular, have, for this purpose, a suitable content of alkali elements, preferably sodium. The glass pane preferably contains from 1 wt.-% to 20 wt.-% sodium oxide (Na₂O). The glass pane can, for example, contain from 40 wt.-% to 90 wt.-% silicon oxide (SiO₂), from 0.5 wt.-% to 10 wt.-% aluminum oxide (Al₂O₃), from 1 wt.-% to 20 wt.-% sodium oxide (Na₂O), from 0.1 wt.-% to 15 wt.-% potassium oxide (K₂O), from 0 wt.-% to 10 wt.-% magnesium oxide (MgO), from 0 wt.-% to 10 wt.-% calcium oxide (CaO), and from 0 wt.-% to 15 wt.-% boron oxide (B₂O₃). The glass pane can, moreover, contain other constituents and impurities.

It has, however, surprisingly been found that certain chemical compositions of the first pane are particularly suitable to be subjected to chemical tempering. This expresses itself in a high speed of the diffusion process, which results in an advantageously low time outlay for the tempering process, and yields large tempered depths (compressive stress depths), which yields stable and fracture resistant glasses. In the context of the invention, these compositions are preferred.

The glass pane advantageously contains an aluminosilicate glass. The first pane preferably contains from 50 wt.-% to 85 wt.-% silicon oxide (SiO₂), from 3 wt.-% to 10 wt.-% aluminum oxide (Al₂O₃), from 8 wt.-% to 18 wt.-% sodium oxide (Na₂O), from 5 wt.-% to 15 wt.-% potassium oxide (K₂O), from 4 wt.-% to 14 wt.-% magnesium oxide (MgO), from 0 wt.-% to 10 wt.-% calcium oxide (CaO), and from 0 wt.-% to 15 wt.-% boron oxide (B₂O₃). The glass pane can, moreover, contain other constituents and impurities.

The glass pane particularly preferably contains at least from 55 wt.-% to 72 wt.-% silicon oxide (SiO₂), from 5 wt.-% to 10 wt.-% aluminum oxide (Al₂O₃), from 10 wt.-% to 15 wt.-% sodium oxide (Na₂O), from 7 wt.-% to 12 wt.-% potassium oxide (K₂O), and from 6 wt.-% to 11 wt.-% magnesium oxide (MgO). The glass pane can, moreover, contain other constituents and impurities.

The glass pane most particularly preferably contains at least from 57 wt.-% to 65 wt.-% silicon oxide (SiO₂), from 7 wt.-% to 9 wt.-% aluminum oxide (Al₂O₃), from 12 wt.-% to 14 wt.-% sodium oxide (Na₂O), from 8.5 wt.-% to 10.5 wt.-% potassium oxide (K₂O), and from 7.5 wt.-% to 9.5 wt.-% magnesium oxide (MgO). The glass pane can, moreover, contain other constituents and impurities.

The glass pane, the polymeric pane, and/or the intermediate layer can be clear and colorless, but can also be tinted or colored.

The composite pane according to the invention can be flat. Flat vehicle panes occur in particular as large area glazings of buses, trains, or tractors. The composite pane according to the invention can, however, also be slightly or greatly curved in one or a plurality of spatial directions. Curved panes occur, for example, in glazings in the automotive sector, wherein typical radii of curvature are in the range from roughly 10 cm to roughly 40 m.

The composite pane can have a functional coating, for example, an IR-reflecting or absorbing coating, a UV-reflecting or absorbing coating, a coloring coating, a low emissivity coating (so-called low E coating), a heatable coating, a coating with an antenna function, a coating with splinter binding action (splinter-free coating), or a coating for shielding against electromagnetic radiation, for example, radar radiation. In a preferred embodiment, the coating according to the invention is an electrically conductive coating. Thus, it is possible to realize, in particular, a low emissivity coating, an IR reflecting coating, or a heatable coating.

The functional coating is preferably applied on a surface of the polymeric pane or on a carrier film within the intermediate layer. The carrier film preferably contains at least polyethylene terephthalate (PET), polyethylene (PE), or mixtures or copolymers or derivatives thereof and preferably has a thickness of 5 μm to 500 μm, particularly preferably 10 μm to 200 μm. This is particularly advantageous for the handling, the stability, and the optical properties of the carrier film.

In an advantageous improvement of the invention, the surface of the polymeric pane facing away from the glass pane is provided with a protective coating. As a result, the scratch resistance of the pane is further increased. Preferably, thermally curing or UV curing lacquer systems based on polysiloxanes, polyacrylates, polymethyl acrylates, and/or polyurethanes are used. The protective coating preferably has a layer thickness of 1 μm to 50 μm, particularly preferably of 2 μm to 25 μm.

The invention further comprises a method for producing a composite pane according to the invention, wherein
a polymeric pane is produced,
a glass pane is provided, and
the polymeric pane is bonded to the glass pane in a planar manner.

The polymeric pane is preferably produced by injection molding.

The glass pane is preferably chemically tempered.

The glass pane is preferably produced as flat glass and cut to the desired size and shape. If the composite pane to be produced has only one curve in one direction, the flat pane can, because of its low thickness, be bent directly during bonding to the polymeric pane.

However, particularly in the automotive sector, bends in a plurality of spatial directions appear as a rule. In this case, the glass pane preferably obtains its final three-dimensional shape before the chemical tempering. For this, the glass pane is subjected to a bending process at elevated temperatures, for example, at 500° C. to 700° C.

After bending, the pane is slowly cooled. Excessively rapid cooling creates thermal stresses in the pane that can result in shape changes during the subsequent chemical tempering. The cooling rate is preferably from 0.05° C./sec to 0.5° C./sec until cooling to a temperature of 400° C., particularly preferably from 0.1-0.3° C./sec. By means of such slow cooling, thermal stresses in the glass which result in particular in optical defects as well as in a negative impact on the subsequent chemical tempering can be prevented. Thereafter, it can be further cooled even at higher cooling rates, because below 400° C., the risk of generating thermal stresses is low.

The chemical tempering is preferably done at a temperature of 300° C. to 600° C., particularly preferably 400° C. to 500° C. The glass pane is treated with a salt melt, for example, immersed in the salt melt. During the treatment, in particular, sodium ions of the glass are exchanged for larger ions, in particular larger alkali ions, creating the desired surface compressive stresses. The salt melt is preferably the melt of a potassium salt, particularly preferably potassium nitrate (KNO₃) or potassium sulfate (KSO₄), most particularly preferably potassium nitrate (KNO₃).

The ion exchange is determined by the diffusion of the alkali ions. The desired values for the surface compressive stresses can consequently be adjusted in particular by the temperature and the duration of the tempering process. Customary times for the duration are from 2 hours to 48 hours.

After the treatment with the salt melt, the pane is cooled to room temperature. Then, the pane is cleaned, preferably with sulfuric acid (H₂SO₄).

The polymeric pane and the glass pane are bonded to each other preferably by lamination via a thermoplastic intermediate layer. The production of the composite glass by lamination is done using methods known per se, for example, autoclave methods, vacuum bag methods, vacuum ring methods, calendar methods, vacuum laminators, or combinations thereof. The bonding of the glass pane and the polymeric pane is customarily done under the action of heat, vacuum, and/or pressure.

The composite pane according to the invention is preferably used in means of transportation for travel on land, in the air, or on water, in particular in trains, ships, and motor vehicles, for example, as a windshield, roof panel, rear window, or side window.

The invention further comprises the use of a glass pane, preferably a chemically tempered glass pane having a thickness of preferably less than or equal to 1 mm, in a composite pane to increase the stability and scratch resistance of a polymeric pane, preferably a vehicle pane, particularly preferably a windshield, side window, rear window, or roof panel.

In the following, the invention is explained in detail with reference to drawings and exemplary embodiments. The drawings are schematic representations and not true to scale. The drawings in no way restrict the invention.

They depict:

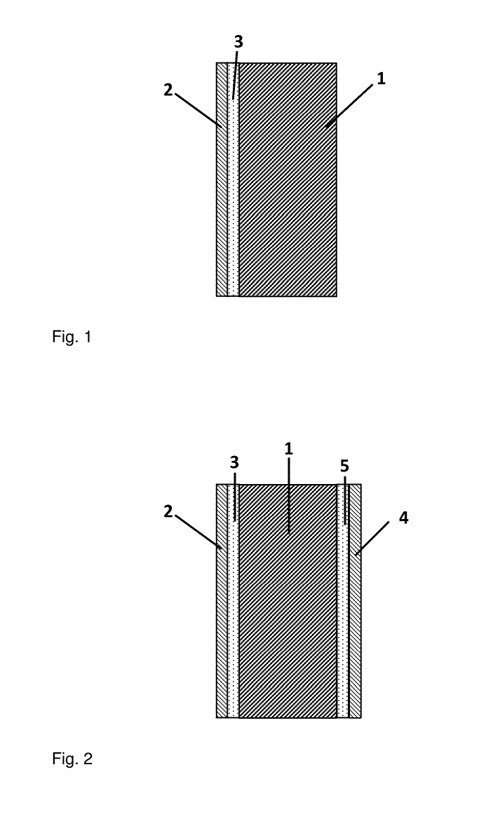

FIG. 1 a cross-section through one embodiment of the composite pane according to the invention,

FIG. 2 a cross-section through another embodiment of the composite pane according to the invention,

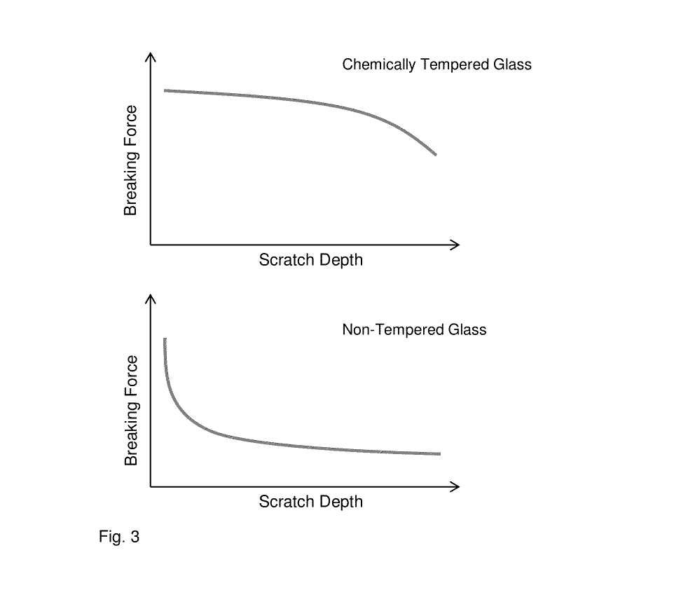

FIG. 3 a schematic diagram of the break stability of chemically tempered and non-tempered glass as a function of scratch depth, and

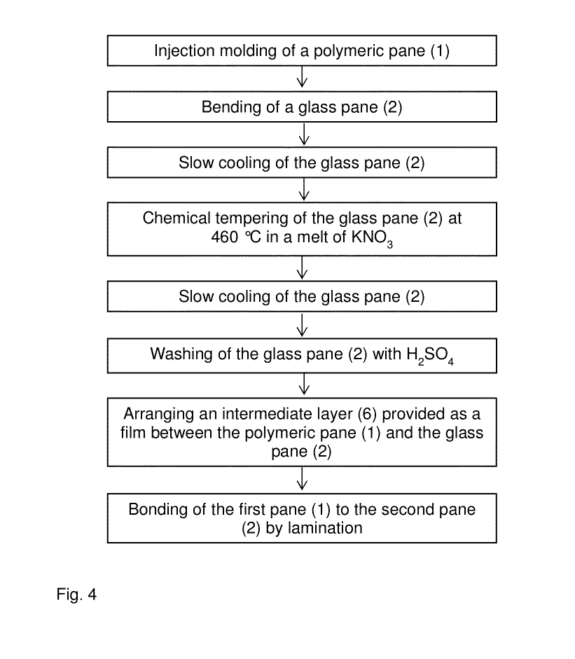

FIG. 4 a flowchart of an embodiment of the method according to the invention.

FIG. 1 depicts a composite pane according to the invention, which is made of a polymeric pane 1 and a glass pane 2, which are bonded to each other via an intermediate layer 3. The composite pane is, for example, intended as a side window of a motor vehicle, wherein the polymeric pane 1 is the inner pane in the installed position and the glass pane 2 is the outer pane. The polymeric pane 1 thus faces the interior of the motor vehicle and the glass pane 2 faces the external environment.

The polymeric pane 1 is made of polycarbonate (PC) and has a thickness of 3 mm. As a result of the polymeric pane 1, the composite pane has an advantageously low weight. The glass pane 2 has a thickness of, for example, 0.5 mm. The thin glass pane 2 increases the weight of the composite pane only slightly, but significantly improves the stability and scratch resistance as well as the acoustic properties.

The intermediate layer 3 is made of polyurethane (PU) having a thickness of roughly 0.8 mm. During lamination of the polyurethane intermediate layer and the polycarbonate pane, surprisingly, less diffusion between the intermediate layer 3 and the polymeric pane 1 occurs than with many other customary thermoplastic materials, such as PVB.

In order to obtain improved stability, the glass pane 2 is chemically tempered. The compressive stress depth is greater than 50 μm, for example, roughly 100 μm, and the surface compressive stress is, for example, 250 MPa, with even substantially higher values, for example, roughly 400 MPa, realizable and can be desirable in the individual case. Due to the low thickness of the glass pane 2, corresponding tempering would not be achievable using thermal methods.

The chemical composition of the glass pane 2 is presented in Table 1, with the missing portion resulting from admixtures and impurities. The composition is particularly suited to being subjected to chemical tempering.

TABLE 1

| Constituent | wt.-% |
|---|---|
| SiO₂ | 60.7 |
| Al₂O₃ | 7.7 |
| Na₂O | 13.1 |
| K₂O | 9.6 |
| MgO | 8.4 |

FIG. 2 depicts another embodiment of the composite pane according to the invention. The polymeric pane 1 is bonded via a first intermediate layer 3 to a first glass pane 2 and via a second intermediate layer 5 to a second glass pane 4. The glass panes 2,4, which have, for example, a thickness of 0.2 mm, protect the polymeric pane 1 on both sides against scratching and improve the acoustic properties and the stability of the pane.

FIG. 3 depicts a comparison between the break stability of chemically tempered and non-tempered glass in the form of a schematic diagram. The diagram reports schematically the course of values measured in comparative tests. In the measurements, scratches were produced on chemically tempered and non-tempered glass panes using sandpaper of different grit sizes. This yields the abscissa of the diagram (scratch depth), with the abscissa of the two diagrams the same scale. Then, the force necessary to break the glass pane was measured.

It is discernible that the break stability of non-tempered glass already suffers significantly with scratches of low depth. In contrast, scratches of low and moderate depth have a negligible effect on the break stability of chemically tempered glass, whose break stability is somewhat reduced only with scratches of greater depth.

The diagram clearly illustrates an advantage of the use of chemically tempered glass in the composite pane according to the invention with regard to break stability. This result was unexpected and surprising for the person skilled in the art.

FIG. 4 depicts a flowchart of an exemplary embodiment of the method according to the invention for producing a composite glass according to the invention. A polymeric pane 1 made of polycarbonate is produced by the injection molding method. A glass pane 2 is provided as flat float glass with the chemical composition of Table 1. The glass pane 2 is first brought into its final three-dimensional shape by a bending process. The glass pane 2 is cooled slowly after bending in order to avoid thermal stresses. A suitable cooling rate is, for example, 0.1° C./sec. The glass pane 2 is then treated for a period of a few hours, for example, 4 hours, at a temperature of 460° C. with a melt of potassium nitrate and thereby chemically tempered. The treatment causes a diffusion-driven replacement of sodium ions by larger potassium ions via the surfaces of the glass. Surface compressive stresses are thus generated. The glass pane 2 is then cooled and subsequently washed with sulfuric acid to remove residues of the potassium nitrate.

The polymeric pane 1 and the glass pane 2 and a thermoplastic film made of PU positioned therebetween are arranged as a stack. Then, the pane composite is laminated, for example, using a vacuum bag method, wherein the thermoplastic film forms an intermediate layer 3.

### LIST OF REFERENCE CHARACTERS

(1) polymeric pane
(2) glass pane
(3) intermediate layer
(4) second glass pane
(5) second intermediate layer

1.-15. (canceled)

16. A composite pane for vehicles, comprising:
a polymeric pane having a thickness of 1.5 mm to 10 mm,
wherein the polymeric pane contains one of or both of polycarbonate (PC) and polymethyl methacrylate (PMMA); and
a glass pane having a thickness less than or equal to 1 mm bonded in a planar manner to the polymeric pane,
wherein the glass pane is a chemically tempered glass pane.

17. The composite pane according to claim 16, wherein the chemically tempered glass pane has a thickness of 0.1 mm to 1 mm.

18. The composite pane according to claim 16, wherein the chemically tempered glass pane has a thickness of 0.2 to 0.8 mm.

19. The composite pane according to claim 16, wherein the chemically tempered glass pane has a thickness of 0.4 mm to 0.7 mm.

20. The composite pane according to claim 16, wherein the polymeric pane has a thickness of 2 mm to 5 mm.

21. The composite pane according to claim 16, wherein the polymeric pane has a thickness of 2.5 mm to 4 mm.

22. The composite pane according to claim 16, wherein the polymeric pane has a thickness of 3 mm to 4 mm.

23. The composite pane according to claim 16, wherein the polymeric pane and the glass pane are bonded via a thermoplastic intermediate layer.

24. The composite pane according to claim 23, wherein the thermoplastic intermediate layer has a thickness of 0.2 mm to 1 mm.

25. The composite pane according to claim 23, wherein the thermoplastic intermediate layer contains polyurethane or derivatives thereof.

26. The composite pane according to claim 23, wherein the thermoplastic intermediate layer is configured to have a noise reducing effect.

27. The composite pane according to claim 16, wherein the chemically tempered glass pane has a surface compressive stress greater than 100 MPa.

28. The composite pane according to claim 16, wherein the chemically tempered glass pane has a surface compressive stress greater than 250 MPa.

29. The composite pane according to claim 16, wherein the chemically tempered glass pane has a surface compressive stress greater than 350 MPa.

30. The composite pane according to claim 16, wherein the chemically tempered glass pane has a compressive stress depth of at least one tenth of the thickness of the chemically tempered glass pane.

31. The composite pane according to claim 16, wherein the chemically tempered glass pane has a compressive stress depth of at least one sixth of the thickness of the chemically tempered glass pane.

32. The composite pane according to claim 16, wherein the chemically tempered glass pane is configured as an outer pane of a vehicle.

33. The composite pane according to claim 16, wherein a surface of the polymeric pane facing away from the chemically tempered glass pane is bonded in a planar manner to a second glass pane.

34. The composite pane according to claim 16, wherein the chemically tempered glass pane contains from 55 wt.-% to 72 wt.-% silicon oxide (SiO₂), from 5 wt.-% to 10 wt.-% aluminum oxide (Al₂O₃), from 10 wt.-% to 15 wt.-% sodium oxide (Na₂O), from 7 wt.-% to 12 wt.-% potassium oxide (K₂O), and from 6 wt.-% to 11 wt.-% magnesium oxide (MgO).

35. A method for producing a composite pane, comprising:
producing a polymeric pane having a thickness of 1.5 mm to 10 mm,
wherein the polymeric pane contains one of or both of polycarbonate (PC) and polymethyl methacrylate (PMMA);
chemically tempering a glass pane having a thickness less than or equal to 1 mm; and
bonding the polymeric pane to the chemically tempered glass pane in a planar manner.

36. The method according to claim 35, further comprising, prior to chemically tempering a glass pane,
bending the glass pane at a temperature of 500° C. to 700° C.; and
cooling the glass pane to a temperature of 400° C. at a cooling rate from 0.05° C./sec to 0.5° C./sec.

37. The method according to claim 35, wherein chemically tempering a glass pane includes immersing the glass pane in a salt melt at a temperature of 300° C. to 600° C. for a period of 2 hours to 48 hours.

38. The method according to claim 35, wherein chemically tempering a glass pane includes immersing the glass pane in a potassium nitrate (KNO₃) melt at a temperature of 300° C. to 600° C. for a period of 2 hours to 48 hours.

39. A method of using a composite pane having a chemically tempered glass pane to increase the stability and scratch resistance of a polymeric pane in a vehicle, comprising:
forming a composite pane from
a polymeric pane having a thickness of 1.5 mm to 10 mm,
wherein the polymeric pane contains one of or both of polycarbonate (PC) and polymethyl methacrylate (PMMA), and
a glass pane having a thickness less than or equal to 1 mm bonded in a planar manner to the polymeric pane,
wherein the glass pane is a chemically tempered glass pane; and
installing the composite pane in a windshield, side window, rear window or roof panel of a vehicle.
